(19) United States
(12) Patent Application Publication
(10) Pub. No.: US 2006/0075649 A1
(43) Pub. Date: Apr. 13, 2006

(54) Shingle lay

(76) Inventor: Talmadge Randolph Kyzer, Youngstown, OH (US)

Correspondence Address: TALMADGE R. KYZER JR., APT. 103, 4813 WESTCHESTER DR., YOUNGSTOWN, OH, 44515, US

(21) Appl. No.: 10/676,416

(22) Filed: Oct. 5, 2004

(51) Int. Cl. G01D 21/00

(52) U.S. Cl. 33/648

(57) ABSTRACT

The shingle lay is a tool for aligning Shingles. It is a long corrugated extruded piece of aluminum. It has two ribs that rise vertically. The front rib is one inch from the front and the second is one half inch from the back. It allows many shingles to be layed at one time. It's long corrugated body gives it strength and accuracy. The shingles are layer on the front of the front rib where they lay until they are fastened. A cable with beads at 5″ intervals holds the tool in place as the row of shingles is being fastened.

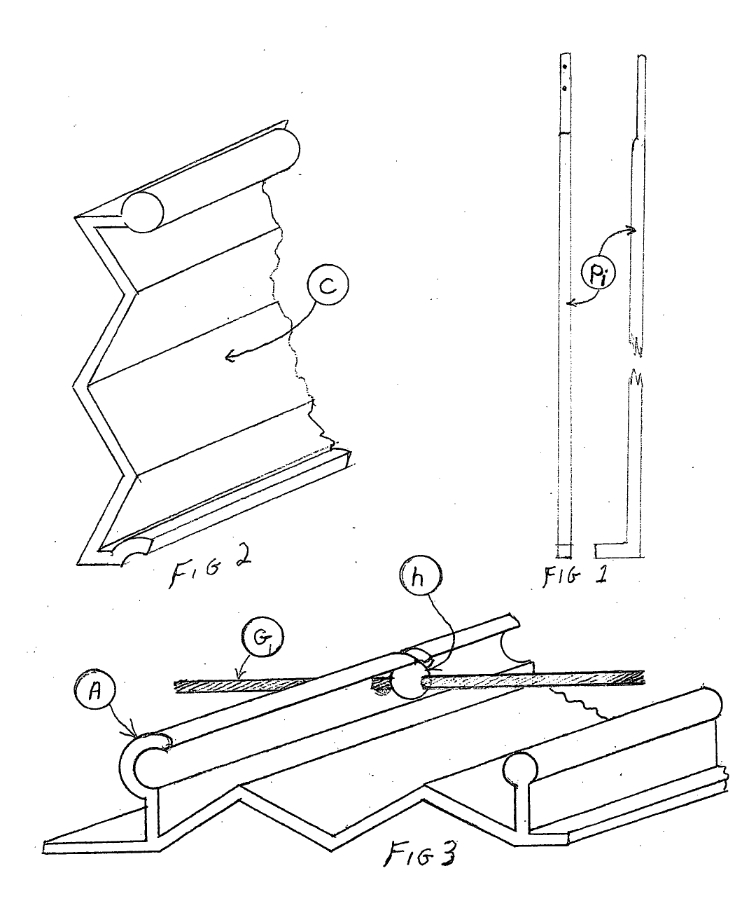

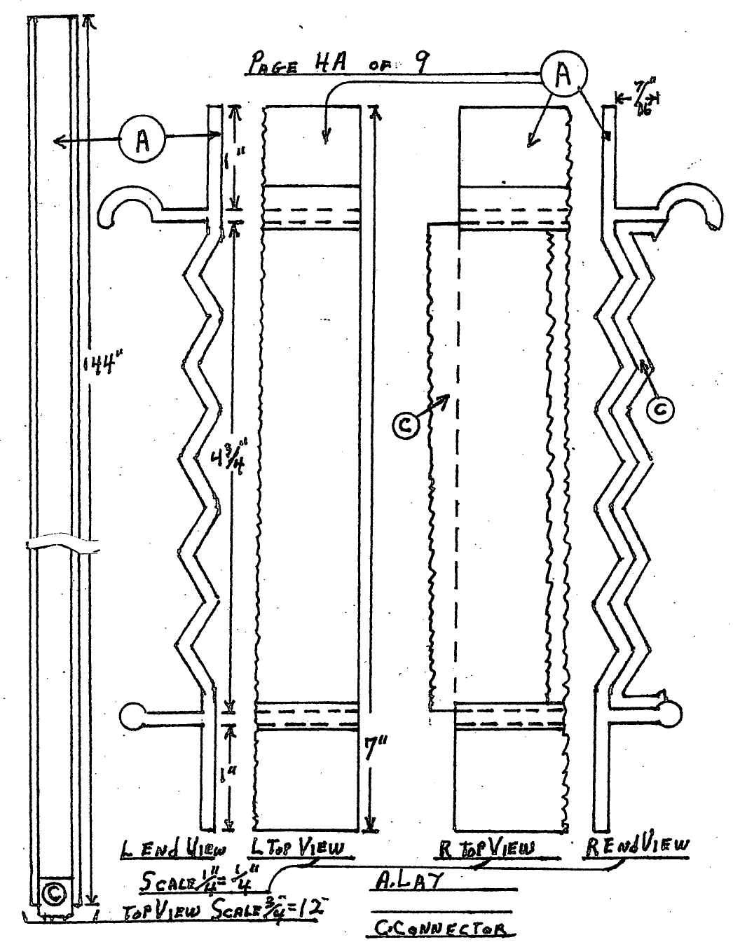

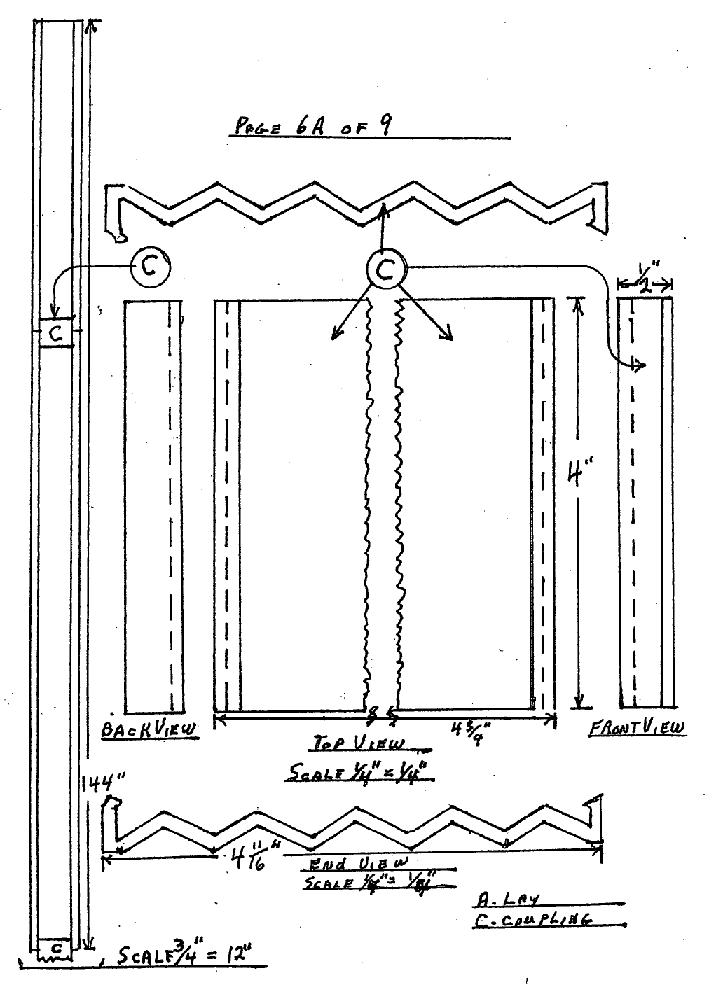

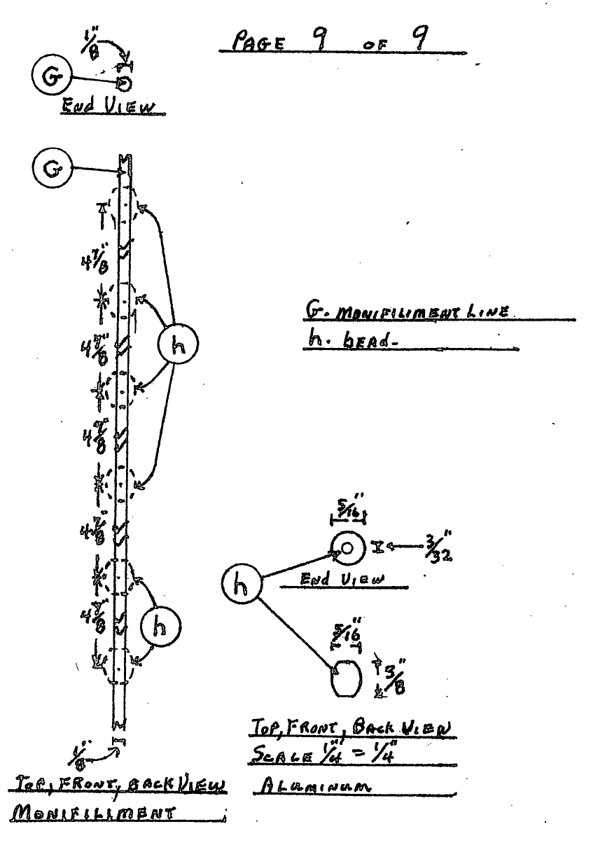

I bring forth this declaration of Shingle Lay. A tool, that is easy to use which is light weight and durable.

The tool will assist workers in there task of putting shingles on homes and other dwellings.

The Shingle Lay is a long, low profile rectangle. 16 foot long, 7″ inches wide with a height of 1″inch.

The low profile keeps the tool out of the workers way. The width and ribs gives it strength.

The Shingle Lay aligns each row of shingles and spaces them at a preset distance. While workers are busy fastening the shingles to the roof. The lay holds the shingles in place.

It is easily advanced to the next row by moving it to the next bead.

Repeating this action over and over as they move up the roof.

Item, A, is made of Aluminum. The dementions, 1″ by 7″ inches. The length varies from 4 feet to 16 feet, The thickness is ⅛″ inch. It will be extruded at ⅛″ inch.

Item A. The front side travels towards the back ⅞″ inch where it junctions with a vertical rib, the rib which rises 7/16″ inches, where it junctions with half of a circle. The circle has an inside measurement of ⅜″ inch.

Traveling towards the back ¼″ inch item, A, meets some folds which travel towards the back 4 and ⅞″ inches to junction with another rail which rises vertically 7/16 inch to join a ¼″, out side measurement, solid circle. Item, A , travels ⅞″ inch behind this back rib.

### Item “C”

Item “C”, is made of Aluminum. The detentions 4″ and 11/16″ inches by ½″ inches with a length of 4″ inches.

It follows the shape of Item “A”, allowing it to attach two Lays together.

It is a coupling. It is also extruded at ⅛″ inch thickness.

### Item “G”

Item's″, is a ⅛″ inch cable, tanglefree, 25′ foot in length.

### Item “H”

Item “H”, is a steel bead or a 3/16′ inch steel wire.

The bead has an outside diameter of ⅜″ inch and a inside diameter of 3/32″ inch.

### Assembly

Item “C”, Attaches to the top left hand end of Item “A”, by welding.

Item “H”, are crimped On Item “G” at 4 and ⅞″ inch intervals.

1. I claim the Shingle Lay an aligning tool for aligning shingles as they are applied to a roof. The Shingle Lay is a long extruded piece of aluminum with a front rib which is 1″, one indh from the front and a second rib, ½″, one half inch from the back. Between the ribs the base is corrugated to give the lay strength.

2. This tool aligns and holds the shingles as the workers are busy fastening the shingles to the roof.

3. The lay is supported by a, ⅛″, one eights inch cable with beads at, 5″, five inch intervals. This aligns the tool for each row of shingles accurately.

4. The lay aligns the starter shingles and holds each row of shingles all the way up the roof.
